(19) United States
(12) Patent Application Publication
(10) Pub. No.: US 2016/0225082 A1
(43) Pub. Date: Aug. 4, 2016

(54) AUTOMATED FINANCIAL INTEREST TRADING PROCESS BASED ON FORMATION CLOSE

(71) Applicant: Right Line Trading, LLC, Miami, FL (US)

(72) Inventor: Mark Sachs, Miami, FL (US)

(21) Appl. No.: 14/614,050

(22) Filed: Feb. 4, 2015

(51) Int. Cl. G06Q 40/04

(52) U.S. Cl. CPC G06Q 40/04

(57) ABSTRACT

A method for performing automated trading activities is disclosed. The method includes providing to a trader, over the communications network, a graphical user interface comprising a display for displaying a particular financial interest, a first button for purchasing long shares in the financial interest at a close of the current formation, a second button for selling short shares in the financial interest at the close of the current formation, and a third button for closing a predefined position in the financial interest at the close of the current formation. The method further includes receiving, over the communications network, market data associated with the financial interest, receiving, over the communications network, a message indicating that the trader has activated the first button, generating an order to purchase a predefined amount of long shares in the financial interest, and issuing said order at the close of the current formation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The disclosed embodiments broadly relate to the field of finance, and more particularly relates to the field of automated trading platforms.

### BACKGROUND OF THE INVENTION

Having a predefined investment and/or trading strategy is crucial in the volatile financial industry. When performing investment and trading activities, it is common for the novice investor to be swept up in the emotions of the market. In the case of a plunging market, mass panic can spread, causing investors to sell. In a bull market, investors buy in large quantities. Trading in a reactionary manner, however, is widely regarded as a poor investment strategy. A much more effective approach is to pre-plan an investment strategy so that an investor's activities are pre-determined and not subject to the emotions associated with the highs and lows of the market.

A commonly-used investment or trading strategy is to enter or exit a position when a particular scenario has occurred. The example investment or trading strategy may be to purchase a stock when said scenario has occurred. An example of such a scenario is when a stock reaches a particular support or resistance level along with a formation close. Currently, however, there are no widely available, automated solutions for implementing such a predefined investment strategy. Further, there are no current solutions that execute such trading activities with adequate speed and fidelity. Thus, today, an investor that seeks to implement the example investment or trading strategy defined above must wait for the scenario to occur, ascertain the price of the stock at formation close and place an order manually for said stock. The problem with this series of steps, however, is that the market moves at such as fast pace, that by the time the trader has finished executing the series of steps above, the price of the stock has moved significantly. This reduces the effectiveness of the predefined trading strategy and can lead to losses.

Therefore, a need exists to overcome the problems with the prior art as discussed above, and particularly for a more efficient way of automating the process of implementing predefined investment or trading strategies in a trading environment.

### SUMMARY OF THE INVENTION

A method on a server communicatively connected to a communications network, the server for facilitating automated trading activities is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

Briefly, according to an embodiment, an automated method, computer system and computer program product for performing automated trading activities is disclosed. The method on a server communicatively coupled with a communications network includes providing to a trader, over the communications network, a graphical user interface comprising a display for displaying a particular financial interest, a first button for purchasing long shares in the financial interest at a close of the current formation, a second button for selling short shares in the financial interest at the close of the current formation, and a third button for closing a predefined position in the financial interest at the close of the current formation. The method further includes receiving, over the communications network, market data associated with the financial interest, receiving, over the communications network, a message indicating that the trader has activated the first button, generating an order to purchase a predefined amount of long shares in the financial interest, and issuing said order at the close of the current formation.

The foregoing and other features and advantages of the disclosed embodiments will be apparent from the following more particular description of the preferred embodiments, as illustrated in the accompanying drawings.

### BRIEF DESCRIPTION OF THE DRAWINGS

The accompanying drawings, which are incorporated in and constitute a part of this disclosure, illustrate various example embodiments. In the drawings:

FIG. 1 is a block diagram illustrating the network architecture of a system for providing management of trading activities over a communications network, in accordance with one embodiment.

FIG. 2A is a block diagram that shows the data flow of a process for providing management of trading activities over a communications network, in accordance with one embodiment.

FIG. 2B is an illustration of a graphical user interface for providing management of trading activities over a communications network, in accordance with one embodiment.

FIG. 3 is a flow chart that shows the control flow of a process for providing management of trading activities over a communications network, in accordance with one embodiment.

FIG. 4 is a block diagram of a computer system for implementing one of the disclosed embodiments.

### DETAILED DESCRIPTION OF THE PREFERRED EMBODIMENTS

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The disclosed embodiments overcome problems with the prior art by allowing a trader to immediately place an order (buy, sell, close position, etc.) immediately upon close of a formation. Today an investor that seeks to implement a trading task (buy, sell, etc.) at the close of a formation must wait until the close of a formation, ascertain the current price of the financial interest, place an order manually for said financial interest and then issue the order. This series of steps take an inordinate amount of time and, seeing as the market moves at a fast pace, by the time the trader has finished placing the order manually, the price of the interest has moved significantly. The disclosed embodiments overcome these problems by allowing the investor to indicate he intends to place an order (buy, sell, close position, etc.) immediately upon close of a formation by pressing a single button, and then immediately placing said order at the close of the formation. This increases the effectiveness of the investor's trading activity and can increase gains. The disclosed embodiments further improves upon the prior art by providing decreasing risk and increasing return on investment. This feature adds to the versatility of existing investment strategies and does not replace or modify an existing investment strategy.

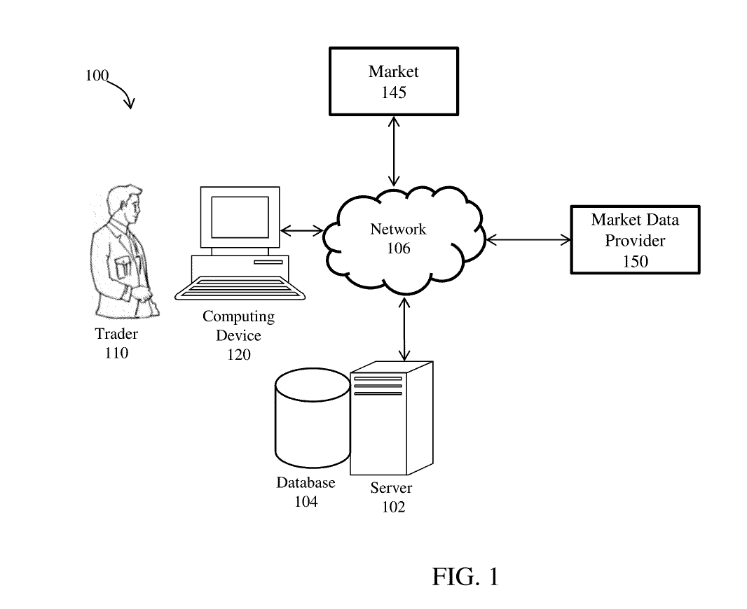

The present invention may be implemented in a computer system that may include a user/investor interface that connects with: 1) a trading entity (such as a financial services company), 2) a market, and 3) a market data provider that provides data about the market. Referring now to the drawing figures in which like reference designators refer to like elements, there is shown in FIG. 1 an illustration of a block diagram showing the network architecture of a system and method for providing management of trading activities over a communications network in accordance with one embodiment.

FIG. 1 shows serer 102 and database 104, which comprise a trading entity. A trading entity may be a trading platform, which is a computer system that can be used to place orders for financial products or financial interests over a network with a market, such as market 145. Trading platforms allow electronic trading to be carried out by users from any location. The trading entity of FIG. 1 may alternatively be a financial services company with an online presence.

The financial products handled by the trading entity of FIG. 1 may include shares, bonds, equities, currencies, futures, stock, options, treasury notes, commodities and derivatives with a financial intermediary, such as brokers, market makers, investment banks or stock exchanges. Financial products may also include equity, fixed-income, financial derivatives, currency, and other investment instruments. Financial products may further include participating in other exchanges such as a put, a put option, short sell, a call or another type of offer or contract to buy or sell at certain predefined prices. Further, an investor may purchase short interests in a financial product (agreements that benefit the investor if the price of the financial interest drops) and long interests in a financial product (agreements that benefit the investor if the price of the financial interest increases). The aforementioned financial products are herein referred to collectively as “interests” or “financial interests.”

A long position in a financial interest, or equivalently to be long in a financial interest, means the holder of the position owns the interest and will profit if the price of the interest goes up. Going long or “buying long” is the more conventional practice of investing and is contrasted with going short. An options investor goes long on the underlying instrument by buying call options or writing put options on it. A long share refers to an instrument that holds a long position in a financial interest.

In contrast, a short position in a futures contract or similar derivative means that the holder of the position will profit if the price of the futures contract or derivative goes down. Thus, short selling (also known as shorting or going short) or “selling short” is the practice of selling a financial interest that is not currently owned, and subsequently repurchasing them (“covering”). In the event of an interim price decline, the short seller will profit, since the cost of (re)purchase will be less than the proceeds which were received upon the initial (short) sale. A short share refers to an instrument that holds a short position in a financial interest. Closing one's position refers to the act of completely vacating a position in a market, which may include selling all long shares and/or buying back all short shares for said position in the market. After closing one's position, the investor is no longer subject to the gains or losses of said position in the market.

FIG. 1 further shows market 145, which may be any one of a variety of systems, institutions, procedures, social relations and infrastructures whereby parties engage in exchange. Examples of a market include stock markets, stock exchanges (such as the New York Stock Exchange), bond markets, commodities markets, currency markets, foreign exchange markets, derivatives markets, prediction markets, and money markets. FIG. 1 also includes market data provider 150, which provides market data about one or more markets. Market data is quote and trade-related data associated with financial products and interests. Market data is numerical price data, reported from trading venues, such as stock exchanges. Market data provider 150 may be a financial data vendor that provides data to financial firms, traders, and investors. The data distributed is collected from sources such as stock exchange feeds, brokers and dealer desks or regulatory filings (e.g., an SEC filing).

The server 102 may be communicatively coupled with a communications network 106, according to an example embodiment. The environment 100 may comprise a computing device 120, which may communicate with server 102 via a communications network 106. Computing device 120 may comprise computing devices such as desktop computers, laptops, and game consoles, for example, and mobile devices such as a cellular telephone, smart phone or tablet computer. The computing device 120 may be connected either wirelessly or in a wired or fiber optic form to the communications network 106. Communications network 106 may be a packet switched network, such as the Internet, or any local area network, wide area network, enterprise private network, cellular network, phone network, mobile communications network, or any combination of the above.

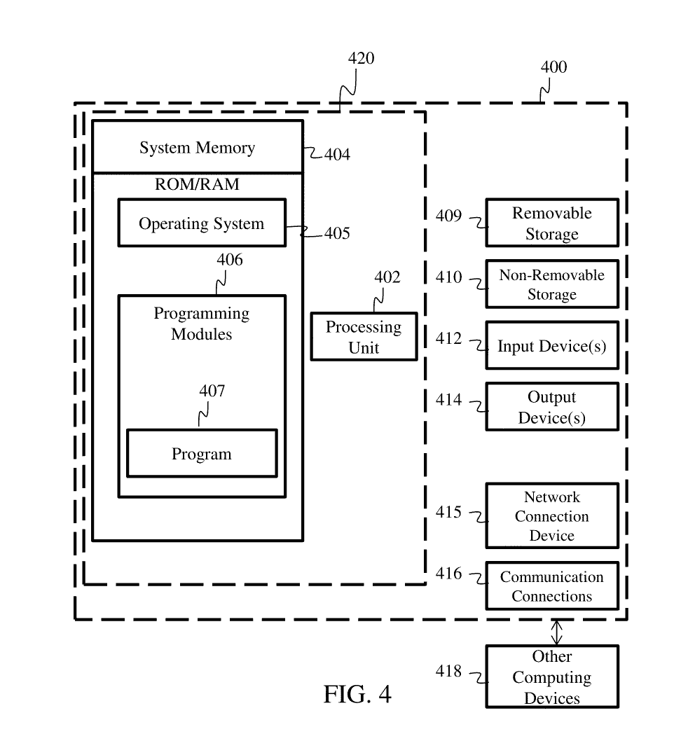

The environment 100 shows that computing device 120 is operated by a user or trader 110 (i.e., an investor). As such, server 102, and device 120 may each comprise a computing device 400, described below in greater detail with respect to FIG. 4.

Server 102 includes a software engine that delivers applications, data, program code and other information to networked device 120. The software engine of server 102 may perform other processes such as transferring multimedia data in a stream of packets that are interpreted and rendered by a software application as the packets arrive. FIG. 1 further shows that server 102 includes a database or repository 104, which may be a relational database comprising a Structured Query Language (SQL) database stored in a SQL server. Computing device 120 may also include its own database, either locally or via the cloud. The database 104 may serve financial data, as well as related information, which may be used by server 102 and computing device 120.

Server 102 and computing device 120 may each include program logic comprising computer source code, scripting language code or interpreted language code that perform various functions of the disclosed embodiments. In one embodiment, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). In another embodiment, the aforementioned program logic may comprise program module 407 in FIG. 4.

It should be noted that although server 102, device 120, market 145 and provider 150 are shown as single and independent entities, in one embodiment, these elements and their functionality can be realized in a centralized fashion in one computer system or in a distributed fashion wherein different elements are spread across several interconnected computer systems. Alternatively, the functions of the aforementioned entities may be integrated with one another in different combinations and permutations. It should further be noted that although FIG. 1 shows only one trader 110, one computer 120, one trading entity 102, one market 145 and one market data provider 150, the system of the disclosed embodiments supports any number of traders, computers, trading platforms, markets and market data providers connected via network 106.

Environment 100 may be used when a trader's computing device 120 engages in trading activities that comprise buying or selling financial interests. Various types of data may be stored in the database 104 of server 102 (as well as data storage on device 120) with relation to each trader and/or each trading activity.

The database 104 may include a user record for each trader 110. A user record may include: contact/identifying information for the trader (name, address, telephone number(s), email address, etc.), information pertaining to financial interests associated with the user, electronic payment information for the user, information pertaining to purchases made by the user, trading transaction data associated with the user, bank information for the user, etc. A user record may also include a unique identifier for each user, a residential address for each user, and a description of past financial interests purchased by each user. A user record may further include demographic data for each user, such as age, sex, income data, race, color, marital status, etc.

Trading transaction data may include one or more financial interest identifiers, one or more financial interest amounts and electronic payment information. In one embodiment, electronic payment information may comprise trader contact/identifying information, bank account information for the trader and any data garnered from a purchase card (i.e., purchase card data), as well as any authentication information that accompanies the bank account or purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

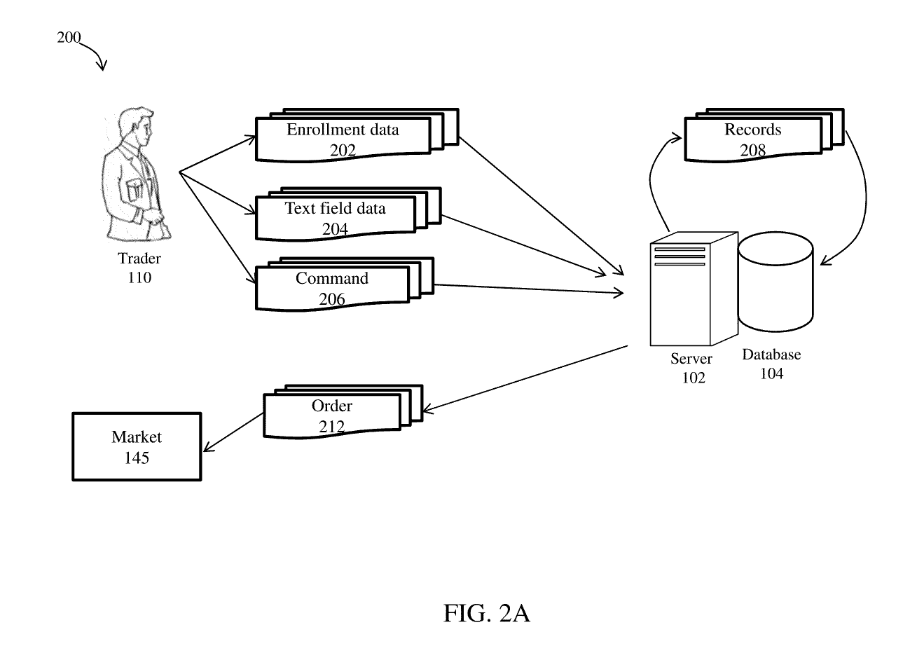

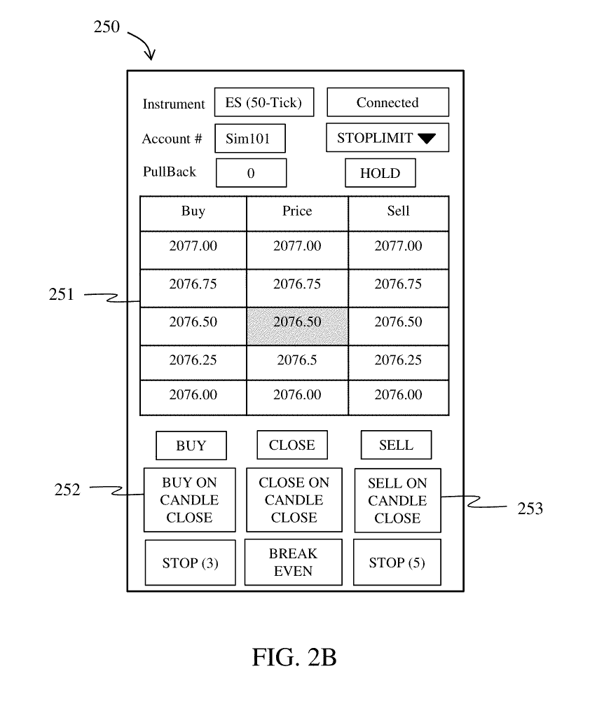

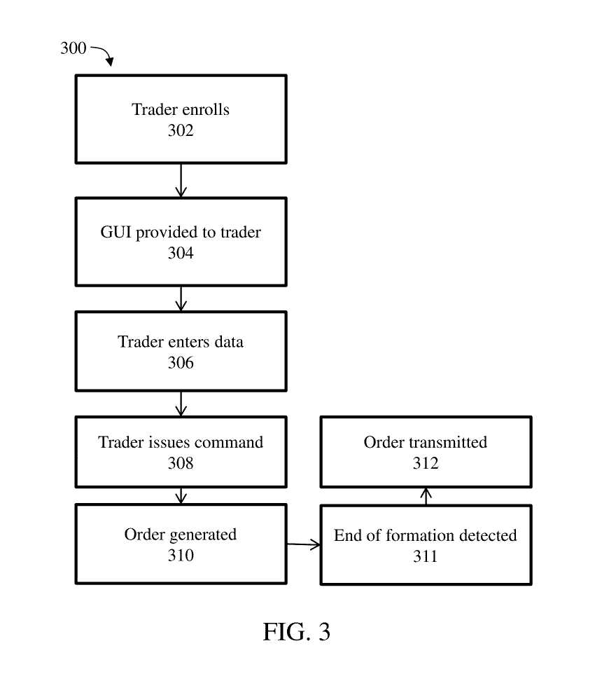

The disclosed embodiments will now be described with references to FIGS. 3, 2A and 2B. FIG. 3 is a flow chart that shows the control flow of the process for providing management of trading activities over the communications network 106, while FIG. 2A is a block diagram that shows the data flow of the process for providing management of trading activities over the network. FIG. 2B is an illustration of a graphical user interface for providing management of the trading activities over the network 106.

The process of the disclosed embodiments begins with optional step 302 (see flowchart 300), wherein the trader 110 may enroll or register with the trading entity or server 102. In the course of enrolling or registering, trader 110 may enter enrollment data 202 into his device 120 by manually entering data into an application via keypad, touchpad, or via voice. In the course of enrolling or registering, the trader 110 may enter any data that may be stored in a user record, as defined above. Also in the course of enrolling or registering, the server 102 may generate a user record 208 for each registering user and store the user record in an attached database, such as database 104.

In the next step 304, the server 102 provides a graphical user interface (GUI) 250, such as shown in FIG. 2B, to the device 120 of trader 110 over network 106. The GUI 250 may include a display for displaying a particular financial interest, such as its name, ticket symbol, or other unique identifier. The GUI 250 may also include a dynamic display 251 for displaying, in real time, a current price of a particular financial interest, wherein the current price is updated frequently, such as at least once per second. The server 102 periodically receives, over the communications network 106, market data associated with the current price of the financial interest. Then, the server 102 updates, over the communications network 106, the dynamic display to reflect the current price of the financial interest. The updating may occur in real time. The term real time, in telecommunications and computing, refers to the time delay introduced by automated data processing or network transmission between the occurrence of an event and the use of the processed data, such as for display. In the disclosed embodiments, the only delay introduced between the updating of the price of a financial interest at the market data provider 150 and the display of the updated price at a recipient's computer 120 is the time necessary for the data to travel between the two computers, which is a negligible time delay.

It should be noted that trader-selected financial interests (their prices, identifiers, and related financial data) may be displayed on the GUI 250. The financial interests may be displayed in various chart styles, such as candlesticks, line on close, open high low close, box, high low, open-close, etc. The chart style determines what form incremental price movement will be displayed on the chart of a financial market. For example, price movement on a chart with a style of “open high low close” will trace out a stick with notches, grooves or flags that represent the high price, low price, open price and close price of the financial market over a pre-defined period. Price movement on a chart with a style of candlestick may display a candle stick with a body and a wick. The candle body would represent the price open and price close and the wick represent the price high and price low of the period. It should be noted that candlesticks have many morphological variations. Also, the aforementioned chart styles may be formatted into various chart types such as range, tick, volume, time [second(s), minute(s), day(s), week(s), month(s), year(s)], Kagi, Renko, point and figure, line break, etc. Each chart type utilizes different specific parameters to define itself. Such parameters may include time, volume, or a predefined change in market price, etc. For example, a tick bar will form every time the market changes a pre-determined number of ticks. A volume bar will form every time the market moves a pre-define volume. The combination of a chart type and a chart style define a formation. In the examples above, each tick bar is a formation and each volume bar is a formation.

For example, a chart with a chart type defined in seconds (in this case, 30 seconds) and a chart style defined as candlestick, will create a formation comprising a candlestick graphic once every 30 seconds. A chart with a chart type defined as range and a chart style defined as “open high low close”, will create a formation comprising an “open high low close” bar every time the financial market moves a pre-determined price. In another example, a chart type of Renko combined with a chart style of “open-close” (with a predefined change in market price) will create a formation comprising a brick shaped graphic every time the financial market moves either up or down the pre-defined amount.

The GUI 250 may further include a button 252 for buying long, or purchasing a long interest, in the financial interest at a close of the current formation, a button 253 for selling short, or purchasing a short interest, in the financial interest at the close of the current formation, a button for closing one or more positions in the financial interest at the close of the current formation, a field (such as a text field) for entering a trigger price and a number of ticks below a trigger price, a button for purchasing the financial interest at a close of the current formation at a specified number of ticks below a specified trigger price, a field (such as a text field) for entering a trigger price and a number of ticks above a trigger price, and a button for selling short in the financial interest at the close of the current formation at a specified number of ticks above a specified trigger price.

Returning to the flowchart 300, in step 306, the trader 110 may enter data into the text field for entering a trigger price and a number of ticks below a trigger price, and/or the text field for entering a trigger price and a number of ticks above a trigger price. The trader 110 may enter said text field data 204 using a keypad, touch screen, mouse or other method. Said data 204 entered by trader 110 may be transmitted to the server 102 over network 106, for example, via HTTP.

Next, in step 308, the trader 110 may issue an order command 206 by pressing the button 252 for buying long in the financial interest at a close of the current formation, the button 253 for selling short in the financial interest at the close of the current formation, the button for closing one or more positions in the financial interest at the close of the current formation, the button for purchasing the financial interest at a close of the current formation at a specified number of ticks below a specified trigger price, or the button for selling short in the financial interest at the close of the current formation at a specified number of ticks above a specified trigger price.

If trader 110 pushed the button 252 for buying long in the financial interest, then in step 310 the server 102 prepares an order 212 to purchase, for user 110, a predefined amount of the financial interest (which is determined prior to the initiation of the trade).

If trader 110 pushed the button 253 for selling short in the financial interest, then in step 310 the server 102 prepares an order 212 to sell, for user 110, a predefined amount of the short interest in the financial interest (which is also determined prior to the initiation of the trade).

If trader 110 pushed the button for closing its positions in the financial interest, then in step 310 the server 102 prepares an order 212 to sell, for user 110, a predefined amount of the long shares in financial interest and/or to buy back, for user 110, a predefined amount of the short shares of the financial interest.

If trader 110 pushed the button for purchasing the financial interest at a specified number of ticks below a specified trigger price, then in step 310 the server 102 prepares an order 212 to purchase, for user 110, the financial interest at the number of ticks below the trigger price, wherein the number of ticks and the trigger price were previously defined by the trader 110 in the text fields of the GUI 250.

If trader 110 pushed the button for selling short in the financial interest at a specified number of ticks above a specified trigger price, then in step 310 the server 102 prepares an order 212 to purchase, for user 110, short shares in the financial interest at the number of ticks above the trigger price, wherein the number of ticks and the trigger price were previously defined by the trader 110 in the text fields of the GUI 250.

In step 311, the server 102 detects the close of the current formation, and once detected, in step 312 the server 102 immediately transmits the prepared order 212 to the market 145 for execution on the market.

FIG. 4 is a block diagram of a system including an example computing device 400 and other computing devices. Consistent with the embodiments described herein, the aforementioned actions performed by server 102 and device 120 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of server 102 and device 120. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a server communicatively coupled with a communications network, the server for performing automated trading activities, the method comprising:
providing to a trader, over the communications network, a graphical user interface comprising:
a display for displaying a particular financial interest;
a first button for purchasing long shares in the financial interest at a close of the current formation;
a second button for selling short shares in the financial interest at the close of the current formation; and
a third button for closing a predefined position in the financial interest at the close of the current formation;
receiving, over the communications network, market data associated with the financial interest;
receiving, over the communications network, a message indicating that the trader has activated the first button;
generating an order to purchase a predefined amount of long shares in the financial interest; and
issuing said order at the close of the current formation.

2. The method of claim 1, further comprising:
receiving, over the communications network, a message indicating that the trader has activated the second button;
generating an order to purchase a predefined amount of short shares of the financial interest; and
issuing said order at the close of the current formation.

3. The method of claim 3, further comprising:
receiving, over the communications network, a message indicating that the trader has activated the third button;
generating an order to sell a predefined amount of long shares in the financial interest and/or an order to repurchase a predefined amount of short shares in the financial interest; and
issuing said order at the close of the current formation.

4. A method on a server communicatively coupled with a communications network, the server for performing automated trading activities, the method comprising:
providing to a trader, over the communications network, a graphical user interface comprising:
a dynamic display for displaying, in real time, a current price of a particular financial interest, wherein the current price is updated at least once per second;
a first button for purchasing long shares in the financial interest at a close of the current formation;
a second button for selling short shares in the financial interest at the close of the current formation; and
a third button for closing a predefined position in the financial interest at the close of the current formation;
receiving, over the communications network, market data associated with the current price of the financial interest;
updating, over the communications network, the dynamic display to reflect the current price of the financial interest;
receiving, over the communications network, a message indicating that the trader has activated the first button;
generating an order to purchase a predefined amount of long shares in the financial interest; and
issuing said order at the close of the current formation.

5. The method of claim 4, further comprising:
receiving, over the communications network, a message indicating that the trader has activated the second button;
generating an order to purchase a predefined amount of short shares of the financial interest; and
issuing said order at the close of the current formation.

6. The method of claim 5, further comprising:
receiving, over the communications network, a message indicating that the trader has activated the third button;
generating an order to sell a predefined amount of long shares in the financial interest and/or an order to repurchase a predefined amount of short shares in the financial interest; and
issuing said order at the close of the current formation.

7. A method on a server communicatively coupled with a communications network, the server for performing automated trading activities, the method comprising:
providing to a trader, over the communications network, a graphical user interface comprising:
a dynamic display for displaying, in real time, a current price of a particular financial interest, wherein the current price is updated at least once per second;
a first field for entering a trigger price and a number of ticks below a trigger price the market must move to execute said trade;
a first button for purchasing long shares in the financial interest at a close of the current formation at a specified number of ticks below a specified trigger price;
a second field for entering a trigger price and a number of ticks above a trigger price;
a second button for selling short shares in the financial interest at the close of the current formation at a specified number of ticks above a specified trigger price; and
a third button for closing a predefined position in the financial interest at the close of the current formation
receiving, over the communications network, market data associated with the current price of the financial interest;
updating, over the communications network, the dynamic display to reflect the current price of the financial interest;
receiving, over the communications network, a message indicating that the trader has entered into the first text field a trigger price and a number of ticks below the trigger price;
receiving, over the communications network, a message indicating that the trader has activated the first button;
generating an order to purchase a predefined amount of long shares in the financial interest at the number of ticks below the trigger price; and
issuing said order at the close of the current formation.

8. The method of claim 7, further comprising:
receiving, over the communications network, a message indicating that the trader has entered into the second text field a trigger price and a number of ticks above the trigger price;
receiving, over the communications network, a message indicating that the trader has activated the second button;
generating an order to sell a predefined amount of short shares in the financial interest at the close of the current formation at the number of ticks above the trigger price; and
issuing said order at the close of the current formation.

9. The method of claim 8, further comprising:
receiving, over the communications network, a message indicating that the trader has activated the third button;
generating an order to sell a predefined amount of long shares in the financial interest and/or an order to repurchase a predefined amount of short shares in the financial interest; and
issuing said order at the close of the current formation.
